(19) United States
(12) Patent Application Publication
(10) Pub. No.: US 2002/0000145 A1
(43) Pub. Date: Jan. 3, 2002

(54) MACHINE FOR CUTTING SHEETS OF MATERIALS IN STACKS

(76) Inventor: GERD GOTTSCHALK, DEUTSCHE (DE)

Correspondence Address: DR MAX FOGIEL, 61 ETHEL ROAD WEST, PISCATAWAY, NJ, 08854

(21) Appl. No.: 09/351,970

(22) Filed: Jul. 12, 1999

(30) Foreign Application Priority Data
Jul. 16, 1998 (DE) 198 31 919.3

(51) Int. Cl. B26D 5/20

(52) U.S. Cl. 83/76.9; 700/84; 83/86

(57) ABSTRACT

A machine for cutting sheets of material in stacks. The machine has a counter that supports the material, a blade for cutting the material, a hold-down that descends onto the material being cut and a saddle for advancing it toward the blade, a keyboard with alphanumeric characters, icons, etc. for operating the machine, a processor for processing input from the keyboard, and a display for displaying the state of the machine and/or the cutting program.

The machine in accordance with the present invention is characterized by an additional display (12) in the form of a modifiable touchscreen next to the main screen (11) and displaying alphanumeric characters (17) and/or program icons (18) and/or a finger-actuated virtual mouse (19). Both the display and the touchscreen matrix are controlled by the processor.

Such a machine can be optimally operated and its operator optimally guided through the process.

The present invention concerns a machine for cutting sheets of material in stacks. The machine has a counter that supports the material, a blade for cutting the material, a hold-down that descends onto the material being cut and a saddle for advancing it toward the blade, a keyboard with numbers, letters, icons, etc. for operating the machine, a processor for processing input from the keyboard, and a display for displaying the state of the machine and/or the cutting program.

A stacked-material cutting machine of this genus is known from German 19 637 027 A1. It performs several functions and carries out various menu commands. Operating the machine accordingly demands a relatively complicated keyboard with a lot of keys. The character formats cannot be altered at will from the keyboard alone. There is no simple way for example to convert the keys to display non-Roman characters.

A materials-cutting machine disclosed in German 9 408 919 U1 has not only a display screen and a keyboard but a touchscreen superimposed over the display screen. Programmed support of an icon associated with a particular command or function through a particular key is accordingly possible. The key can be doubly assigned to display the icon associated with the particular function. Touchscreens employed in this way entail decisive drawbacks. The screen, which is actually intended only to monitor the state of the machine and the course of the operation, can be dirtied by frequent touching on the part of the operator. The characters and icons must be large enough to allow even an operator with thick fingers to run the machine without error. Finely detailed and demanding graphics cannot be represented. Various operating systems can accordingly be handled only with considerable difficulty on a touchscreen. Although specific operating systems, Windows for instance, can be employed with a multiplicity of applications programs, many such applications cannot use conventional touchscreens. Finally, large characters and icons can occupy considerable screen territory. When an image of the keyboard is displayed accordingly, only a small area of the screen is left over for the actual text. In some cases, however, such text requires the full screen, and additional keys cannot be displayed. No really satisfactory touchscreen has accordingly been developed for machines of this genus.

The object of the present invention is accordingly an improved materials-cutting machine of the aforesaid genus that can be optimally operated without the aforesaid state-of-the-art drawbacks, guiding the operator through all the steps of the procedure.

This object is attained in accordance with the present invention in a materials-cutting machine of the aforesaid genus by an additional display in the form of a modifiable touchscreen next to the main screen and displaying alphanumeric characters and/or program icons and/or a virtual finger-actuated mouse, whereby both the display and the touchscreen matrix are controlled by the processor.

The additional modifiable display next to the main display as viewed by the operator and not superimposed over it allows all the advantages of a touchscreen with none of the aforesaid drawbacks. The additional display can replace almost all the alphanumeric and function keys and can be located within the operator's reach in place of a conventional keyboard. The processor, which has up to now been responsible only for processing input from the keyboard, now also takes over the tasks of controlling the additional display and touchscreen. Whereas the mechanical and operational events of importance to the operator are displayed on the main screen, the processor will display the icons needed to represent the alphanumeric and function keys along with the mouse on the supplementary display and will monitor the touch matrix. The alphanumeric characters and icons can be displayed as large as necessary on the supplementary display without covering up any of the important information or instructions displayed on the main screen. It will no longer be necessary to take functions into account when designing the display's masks. When the processor adds a finger actuated virtual mouse to the supplementary display, the mouse will be able to handle all functions. If the operator for example touches the supplementary display, the virtual mouse will appear in the main display, and, if he moves his finger over the supplementary display the mouse will follow the motion in synchronization. Clicking once or twice on various items will be replaced by tapping the display with the fingertip for instance. The virtual mouse's resolution and refreshment rate can be adjusted through the software. Such an image can easily handle a wide range of operating systems—Windows 95 and NT for example. All the applications programs available for these systems can also be run.

The supplementary display is accordingly a “modifiable” “touchscreen” that can entirely handle the materials-cutting machine with no need for a physical keyboard or mouse in the form of a separate component. The operator is guided through all the steps involved in cutting the material, with the processor displaying on the supplementary display whatever alphanumeric and function icons the operator might need at any stage, along with the mouse.

Embodiments of the present invention will now be specified with reference to the accompanying drawing without thereby limiting its scope in any way. All individual features and combinations thereof are essential to the invention.

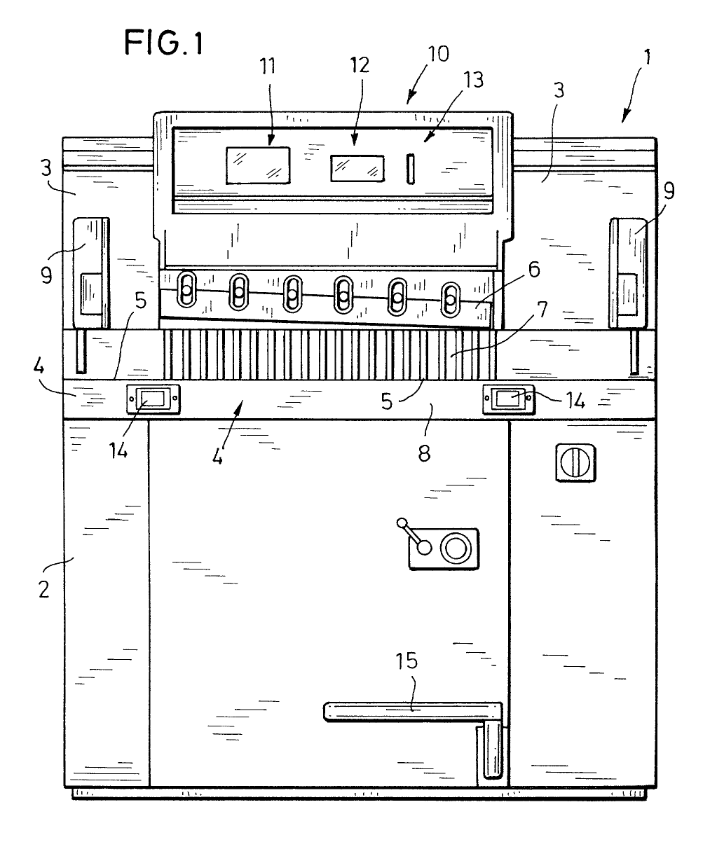

FIG. 1 is a schematic illustration as viewed by the operator of a machine for cutting sheets of material in stacks and

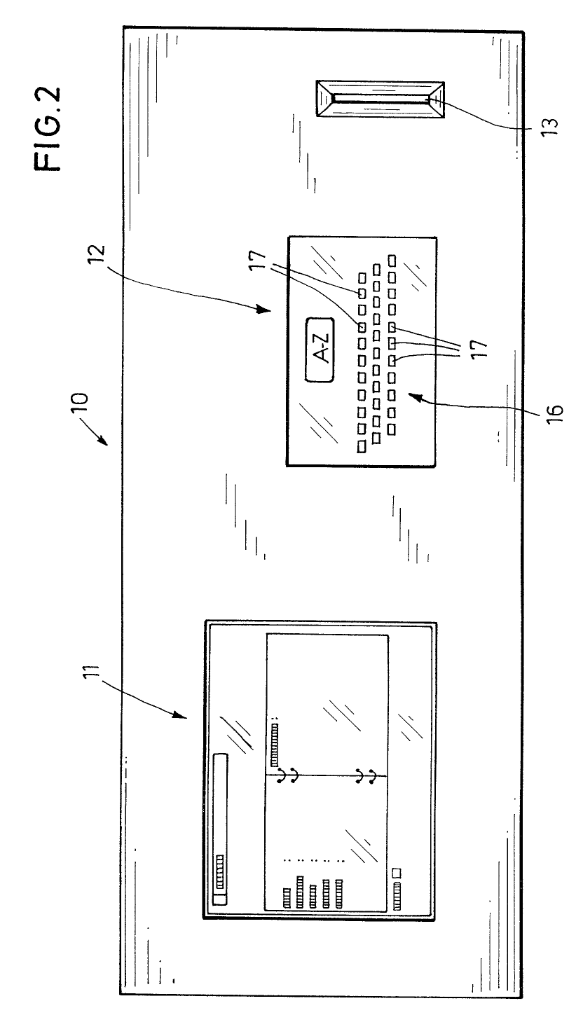

FIGS. 2 through 4 represent the operational area of such a machine with a display in the form of a touchscreen in three different states.

FIG. 1 shows the overall machine 1 as viewed by the operator. Such a machine is employed to cut sheets of material, especially paper, cardboard, plastic, etc. in stacks.

Machine 1 includes a stand 2 with a gantry 3 on top and a counter 4 with its upper surface 5 extending perpendicular to the upper surface of the stack. Accommodated in gantry 3 is a blade 6 that can be raised and lowered. A materials hold-down, invisible from this aspect, can also be raised and lowered in gantry 3. The blade and hold-down can be shifted up and down parallel to the plane of projection. Accommodated at the rear of the counter is a saddle 7 that advances the stack of material being cut to within reach of the blade. The side of stack-advancing saddle 7 facing the operator parallels the cutting direction of blade 6. Mounted on each side of the counter at its front 8 is a light-barrier grating 9 that prevents improper intervention in the vicinity of blade 6. A display-and operations area 10 is located above blade 6 on the operator's side of gantry 3. Area 10 includes a main display 11 and, next to it, a supplementary display 12. Main display 11 is intended to indicate the current state of the machine and/or materials-cutting program in the widest sense of the word, not just the cutting actions themselves, but the overall operation. Supplementary display 12 on the other hand is the modifiable touchscreen to be specified hereinafter. Next to supplementary display 12 is a slot 13 for accommodating replaceable data-storage vehicles in the form of inserted cards. Since these cards can be programmed separately, practically no time need be lost in programming the machine itself. The front of counter 4, finally, accommodates two cutting-initiation switches 14, and the base of the machine a pedal 15 to actuate the cut. Display-and-operations area 10 can also include such further components as a manually operated wheel to correct the position of the saddle.

FIG. 2 is a larger-scale view of display-and-operations area 10, illustrating the main display 11 with initial entries indicating the current state of the machine and/or materials-cutting program, specifically job number, date, paper size, incoming and outgoing count, and comments if any. This data is clearly presented in main display 11 next to the aforesaid types of data represented by the checklist. The latter is entered from a keyboard 16 that can be accessed from supplementary display 12, the processor automatically entering the characters 17, essentially alphanumeric keys, needed for the cutting program, and monitoring the touch matrix.

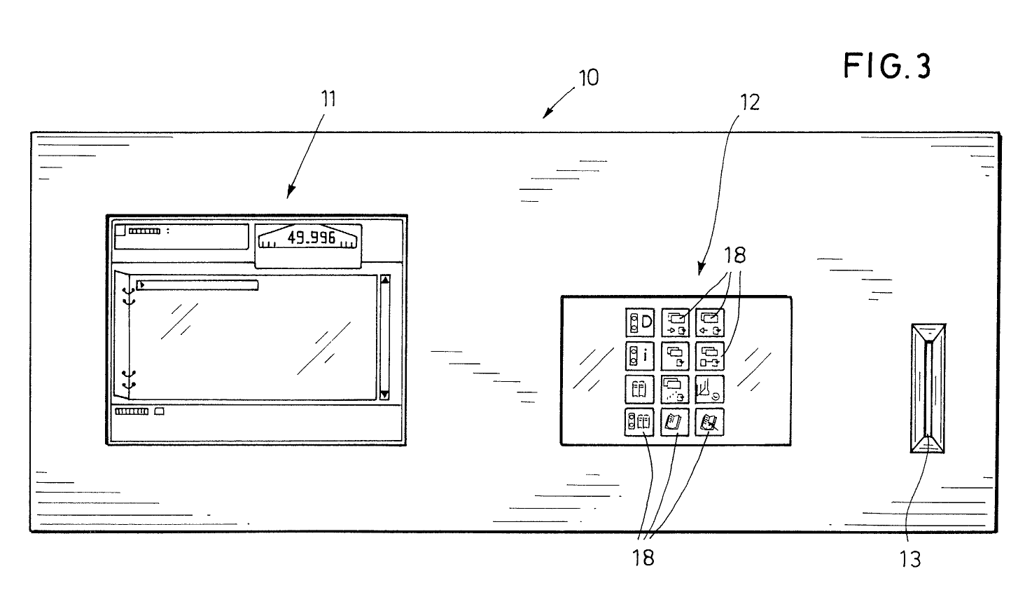

FIG. 3 illustrates supplementary display 12 provided with icons 18 for the requisite functions. These instructions are entered before or while the material is being cut. It will be evident that main display 11 shows a saddle position 49.996 cm, in accordance with which further program steps can be entered by way of supplementary display 12.

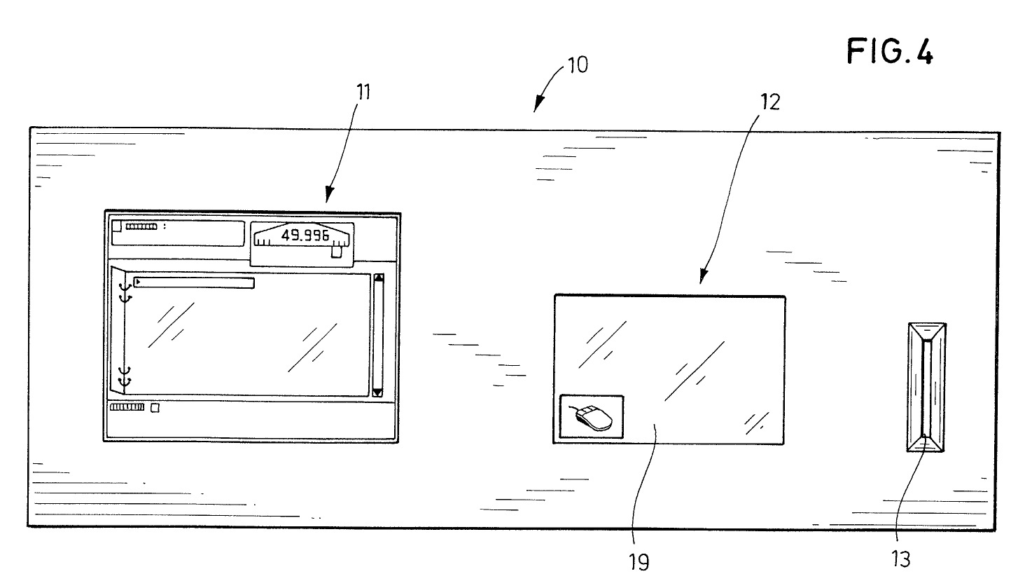

At the stage illustrated in FIG. 4, the processor has transformed supplementary display 12 into a window 19 handled by a finger-controlled virtual mouse whereby the operator can enter the desired functions directly. These functions will be displayed in main display 11.

1. Machine for cutting sheets of material in stacks, with a counter that supports the material, a blade for cutting the material, a hold-down that descends onto the material being cut and a saddle for advancing it toward the blade, a keyboard with alphanumeric characters, icons, etc. for operating the machine, a processor for processing input from the keyboard, and a display for displaying the state of the machine and/or the cutting program, characterized by an additional display (12) in the form of a modifiable touchscreen next to the main screen (11) and displaying alphanumeric characters (17) and/or program icons (18) and/or a finger-actuated virtual mouse (19), whereby both the display and the touchscreen matrix are controlled by the processor.

2. Machine as in claim 1, characterized in that alphanumeric characters (17) and icons (18) representing functions can be entered from the supplementary display (12):

3. Machine as in claim 1 or 2, characterized in that the supplementary display (12) displays only the alphanumeric characters (17) and/or icons (18) that actually function while the machine is in operation.

4. Machine as in one of claims 1 through 3, characterized in that the processor automatically converts the supplementary display (12) from one operated by way of a finger-actuated virtual mouse (19) to one employing alphanumeric characters (17) and icons (18).

5. Machine as in one of claims 1 through 3, characterized in that the processor automatically converts the supplementary display (12) back and forth from one employing alphanumeric characters to one employing icons.
